(19) United States
(12) Patent Application Publication
(10) Pub. No.: US 2008/0178129 A1
(43) Pub. Date: Jul. 24, 2008

(54) Comparator Circuit and Method for Operating a Comparator Circuit

(75) Inventor: Sebastian Ehrenreich, Schoenau (DE)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/965,186

(22) Filed: Dec. 27, 2007

Related U.S. Application Data
(63) Continuation-in-part of application No. 11/782,910, filed on Jul. 25, 2007.

(30) Foreign Application Priority Data
Jul. 25, 2006 (EP) 06117795.2

(51) Int. Cl. G06F 17/50

(52) U.S. Cl. 716/4

(57) ABSTRACT

A design structure embodied in a machine readable medium for designing, manufacturing, or testing a design, the design structure is described. The design structure includes a comparator circuit for comparing a first voltage signal to a second voltage signal comprising a first comparator and a second comparator and a selection unit for selecting one of the comparators depending on a selection condition.

### REFERENCE TO RELATED APPLICATION

This application is a continuation in part of currently co-pending U.S. patent application Ser. No. 11/782,910, which claimed priority from German Patent Application 06117795.2. The contents of both related applications Ser. No. 11/782,910 and 06117795.2 are incorporated by reference herein in their entirety.

### BACKGROUND OF THE INVENTION

The invention relates to a comparator circuit and a method for operating a comparator circuit according to the preambles of the independent claims.

Successive approximation analog-to-digital converters (ADC) are well known in the art. Such ADCs use a comparator to reject ranges of voltages, eventually settling on a final voltage range, and convert one bit per cycle. A typical successive approximation ADC comprises a reference voltage generator, a comparator and a successive approximation register. A general description of this kind of ADCs can be found for example in Allen/Holberg: “CMOS Analog Circuit Design”, Oxford University Press 2002, 668-672.

A single-rail comparator supports a limited input voltage range only. Normally asymmetric input range, starting at some value and ranging to one of the power supply rails. A rail-to-rail comparator supports full input voltage swing, starting at ground and ending at the supply voltage.

Although the algorithm approach does not lead to highest speeds possible in state-of-the-art technologies, this kind of ADCs offers high resolution at low area costs. Additionally, the overall power consumption is low, especially compared to so called flash analog-to-digital converters. Besides other factors the overall conversion accuracy is mainly influenced by the comparator. It is known that offset-errors and gain-errors affect the comparator accuracy. Additionally, the comparator gain is a function of the common mode input voltage which results in limiting the useable input voltage and, further, an available input voltage swing is limited by the input buffer/sample-and-hold circuit, which is usually used at the comparator input.

Various attempts have been made to overcome these problems.

A pipelined ADC architecture which achieves high resolution at high conversion rates is suggested by Won-Chul Song, Hae-Wook Choi, Sung-Ung Kwak and Bang-Sup Song, “A 10-b 20-Msamples/s Low-Power CMOS ADC”, IEEE Journal of Solid-State Circuits, Vol. 30, No. 5, pages 514-521, May 1995. In this paper a latch-type comparator in nMOS technology with an asymmetric output load is disclosed.

Another pipelined algorithmic ADC is disclosed by Hae-Seung Lee, “A 12-b 600 ks/s digitally self-calibrated pipelined algorithmic ADC”, IEEE Journal of Solid-State Circuits, Vol. 29, No. 4, pages 509-515, April 1994.

M. K. Mayes, Sing W. Chin disclose an alternative approach in their paper “A 200 mW, 1 Msample/s, 16-b pipelined A/D converter with on-chip 32-b microcontroller”, IEEE Journal of Solid-State Circuits, Vol. 31, No. 12, page 1868, December 1996.

A time-interleaved ADC combining two three-step flash converters is presented by Michael K. Mayes, Sing W. Chin, Lee L. Stoian, “A Low-Power 1 MHz, 25 mW 12-Bit Time-Interleaved Analog-to-Digital Converter”, IEEE Journal of Solid-State Circuits, Vol. 31, No. 2, pages 169-178, February 1996.

Another comparator ADC with a level shifter is proposed by M. K. Mayes and Sing W. Chin “A 200 mW, 1 Msample/s, 16-b Pipelined A/D Converter with on-chip 32-b Microcontroller”, IEEE Journal of Solid-State Circuits, Vol. 31, No. 12, pages 1862-1872, December 1996.

A rail-to-rail comparator is disclosed in D. Gardino and F. Maloberti “High Resolution Rail-to-rail ADC In CMOS Digital Technology”, Proc. of the ISCAS 1999, Vol. 2, 339-342. This comparator design also needs a rail-to-rail input stage. But as already mentioned above, the comparator is one of the main sources of inaccuracy in such a circuitry. Very low or very high input voltages close to the power supply rail voltages show a very low gain and yield high inaccuracy. However, a rail-to-rail comparator or operational amplifier design introduces additional offset and error sources. Full rail-to-rail operation can still not be achieved.

### SUMMARY OF THE INVENTION

It is therefore an object of the invention to provide a comparator circuit which provides a rail-to-rail operation with high accuracy. Another object is to provide a method for operating the comparator circuit.

The objects are achieved by the comparator circuit and the method according to the independent claims.

The other claims and the description disclose advantageous embodiments of the comparator circuit and the method operating a comparator circuit according to the invention.

A comparator circuit is proposed for comparing a first voltage signal with a second voltage signal, the circuit comprising a first comparator and a second comparator and a selection unit for selecting one of the comparators depending on a selection condition. Advantageously, the gain of each comparator can be chosen independently from each other. Each comparator can be optimized for a different voltage regime, for example for high input voltages or low input voltages. Therefore, each comparator can work at its optimum. With an actual input signal present, the selecting unit advantageously selects one of the comparators according to its optimum voltage regime. Due to this digital selection of that one comparator working in its optimum range, the useable input voltage can be extended from single rail to a rail-to-rail, although each individual comparator can be a single-rail comparator. Due to the digital selection of the proper comparator, introduction of additional offsets and errors can be avoided, and mismatch compared to analog arrangements is avoided, where distortions/mismatch can occur. A degradation of operation speed can be prevented when using the inventive comparator circuit.

High accuracy with low process dependency, low voltage dependency as well as low temperature dependency can be achieved. By expanding the operating voltage range of the comparator circuit according to the invention, a higher resolution for measurements of on-chip data is available, such as thermal sensors, supply voltage sensors, noise sensors. A rail-to rail comparator circuit is provided, although single-rail comparators, preferably performance-optimized single-rail comparators, can be used. A self-calibration comparator mode of operation is possible, providing a still more exact calibration.

Generally spoken, the invention can be applied to any circuit which has a limited operating voltage range, e.g. a reference voltage generator. For such a circuit it is also possible to build two versions, one optimized for low output voltage operation and another one optimized for high output voltage operation. The comparator circuit can be preferably used in a successive approximation analog-to-digital converter and the method can be favorably used for converting analog signals to digital signals.

Preferably, the selection condition is the voltage signal being above or below a threshold voltage. The threshold voltage can be a constant or can be variable.

In a preferred embodiment, the selection unit selects one of the comparators if the voltage level is above the threshold voltage and the other one of the comparators if the voltage level is below the threshold voltage. This yields a high gain, high accuracy comparator circuit. In a preferred analog-to-digital converter, where such a comparator circuit is implemented, this decision is made as a first step of the conversion procedure. Once the most accurate one of the comparators has been selected selected, the conversion can be continued with the selected comparator. Using a successive approximation type of analog-to-digital converter, the selection of the comparator can be included in the first (most significant bit) conversion step, when only a low comparator accuracy is needed.

In a favorable embodiment, one of the comparators is a pMOS (p-channel Metal-Oxide Semiconductor field effect) transistor based device adapted for a first input voltage range and the other one of the comparators is an nMOS (n-channel Metal-Oxide Semiconductor field effect) transistor based device adapted for a second input voltage range. The pMOS-transistor based comparator works best at low input voltage levels, where its gain is high, whereas the gain of the nMOS-based comparator is high at high input voltage levels, yielding the comparator working at its best at high input voltage levels. At an input voltage level in the middle of the supply voltage both types of comparators show comparable gains and accuracies.

In a further preferred embodiment, the selection unit selects the nMOS-based comparator if the voltage level is above the threshold voltage and the pMOS-based comparator is selected if the voltage level is below the threshold voltage. This yields a high gain, high accuracy comparator circuit.

In another preferred embodiment, the selection unit comprises a selection output port, wherein the selection unit connects an output port either of the first comparator or the second comparator to the selection output port, depending on the selection of the selection unit. Thus, the output signal of the selected comparator can be processed further, for example in a preferred ADC or a preferred rail-to-rail comparator building block.

According to a preferred embodiment, the reference voltage is defined by the voltage signals which are being compared by the comparators. Preferably, this is the case for applications in analog-to-digital converters. In such an ADC the reference voltage applied to the comparators is altered step by step during determining the most significant bit down to the least significant bit. In general, such a successive approximation procedure is well known in the art.

According to a further embodiment, means for adjusting the reference voltage depending on the voltage signals which are being compared by the comparators are coupled to the selection unit. This is preferred in an ADC using the successive approximation operation mode.

According to another preferred embodiment, the means comprises a voltage divider and a third comparator with an input port for a threshold voltage and an output port for a digital decision signal. This can be favorably used in a general comparator circuit. Preferably in this embodiment, the third comparator comprises an input port for a voltage signal which is also applied to one of the comparators. In this configuration the third comparator is working as a voltage plane detector. The third comparator can be a single-rail comparator of simple design.

Preferably, in a rail-to-rail comparator building block the selection unit comprises a multiplexor, the output port of which is selectably connectable to one of the comparator output ports via the selection unit. By using a multiplexor, it is not necessary to choose a special kind of comparator type. Additionally or alternatively, it is possible to switch off that one comparator which has not been selected by the selection unit. In this case it may be appropriate to replace the multiplexor by a NAND (Not AND) or a NOR (Not OR) gate. Switching off the comparator means that a strobe signal is not generated in the respective comparator and/or the supply voltage is disconnected or the like. For this purpose it is advisable to choose a comparator with appropriate properties which are well known to skilled persons.

In a very useful embodiment, the comparators are assigned to the comparator stage of an analog-to-digital converter, where, preferably, a sample-and-hold unit is assigned to each of the two comparators.

Principally, it is even possible that at least one of the sample-and-hold units is equipped with a first and a second comparator and a selection unit for selecting one of the comparators depending on a selection condition.

Most preferably, the analog-to-digital converter is of a successive-approximation type.

At least one of the first and second comparators can be a single-rail-type unit. A mismatch as known from analog rail-to-rail solutions as well as a speed degradation can be avoided.

Most preferably, at least one of the first and second comparators is a latch-type device. This yields a very fast comparator circuit. Advantageously, the latch type device is equipped with a dummy inverter yielding a nearly symmetric output.

A method for operating a comparator circuit is proposed, wherein a first voltage signal is compared with a second voltage signal, and either a first comparator or a second comparator is selected depending on a selection condition.

Preferably, the selection condition is the voltage signal being above or below a threshold voltage. The most accurate one of the two comparators can be selected depending on the threshold voltage. Being a digital selection, distortions, inaccuracies as well as speed degradation can be avoided. Further, one of the two comparators is preferably adapted for a first input voltage range and the other is adapted for a second input voltage range essentially different from the first input voltage range.

Particularly, the threshold voltage and/or a reference voltage can be defined by the voltage signals which are being compared by the comparators.

A preferential step is to select an nMOS-based comparator if the voltage level is above the threshold voltage and a pMOS-based comparator if the voltage level is below the threshold voltage. Each comparator can work in an input voltage range where its gain is high, yielding a high accuracy voltage comparison.

An analog-to-digital conversion can be made, wherein in or during a first step one of the comparators is chosen depending on the threshold voltage as selection decision.

Favorably, in the beginning of the successive approximation analog-to-digital conversion the selection of one of the comparators and a first analog-to-digital conversion is performed in the same step.

### BRIEF DESCRIPTION OF THE DRAWINGS

The present invention together with the above-mentioned and other objects and advantages may best be understood from the following detailed description of the embodiments, but not restricted to the embodiments, wherein is shown in:

FIG. 1 a first preferred embodiment in the form of a rail-to-rail comparator building block;

FIG. 2 a second preferred embodiment in the form of an analog-to-digital converter;

FIGS. 3a, b a preferred pMOS based comparator (a) and a preferred nMOS based comparator (b);

FIG. 4 a flow diagram of a successive-approximation algorithm applied on the preferred analog-to-digital converter of FIG. 2; and

FIG. 5 a flow diagram of a design process used in semiconductor design, manufacturing, and/or test.

In the drawings identical elements or elements with identical functions are referred to with the same reference numeral.

### DETAILED DESCRIPTION

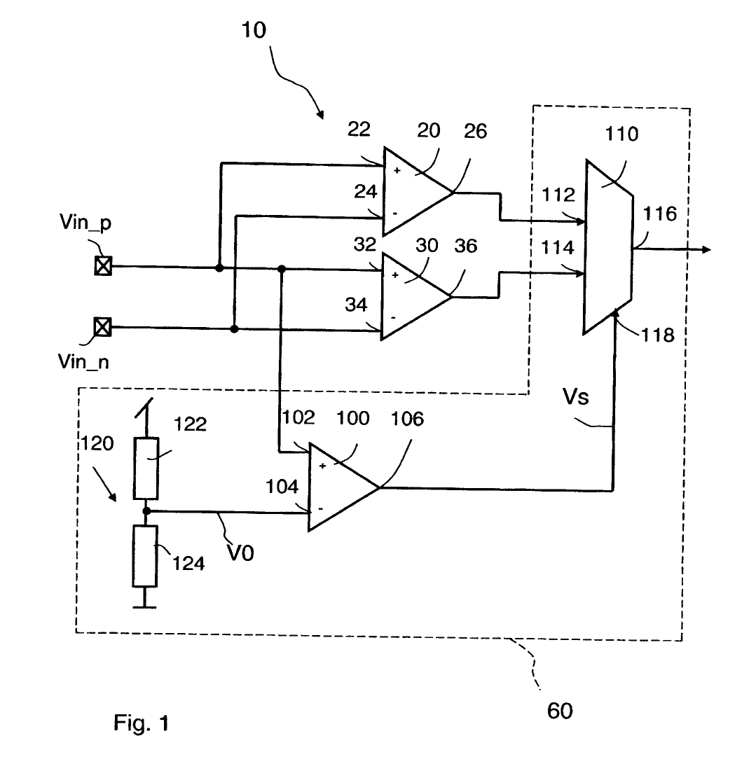

A preferred embodiment of the invention is depicted in FIG. 1. A comparator circuit comprises a first comparator 20 and a second comparator 30 and a selection unit 60. The selection unit 60 is indicated with a dotted line. In this embodiment, the comparator circuit represents a high accuracy rail-to-rail comparator building block.

An input voltage signal Vin_p is fed into an input port 22 and an input voltage signal Vin_n is fed into an input port 24 of the first comparator 20. An output port 26 of the first comparator 20 feeds an output signal to the selection device 60.

An input voltage signal Vin_p is fed into an input port 32 and an input voltage signal Vin_n is fed into an input port 34 of the second comparator 30. An output port 36 of the second comparator 30 feeds an output signal to the selection unit 60.

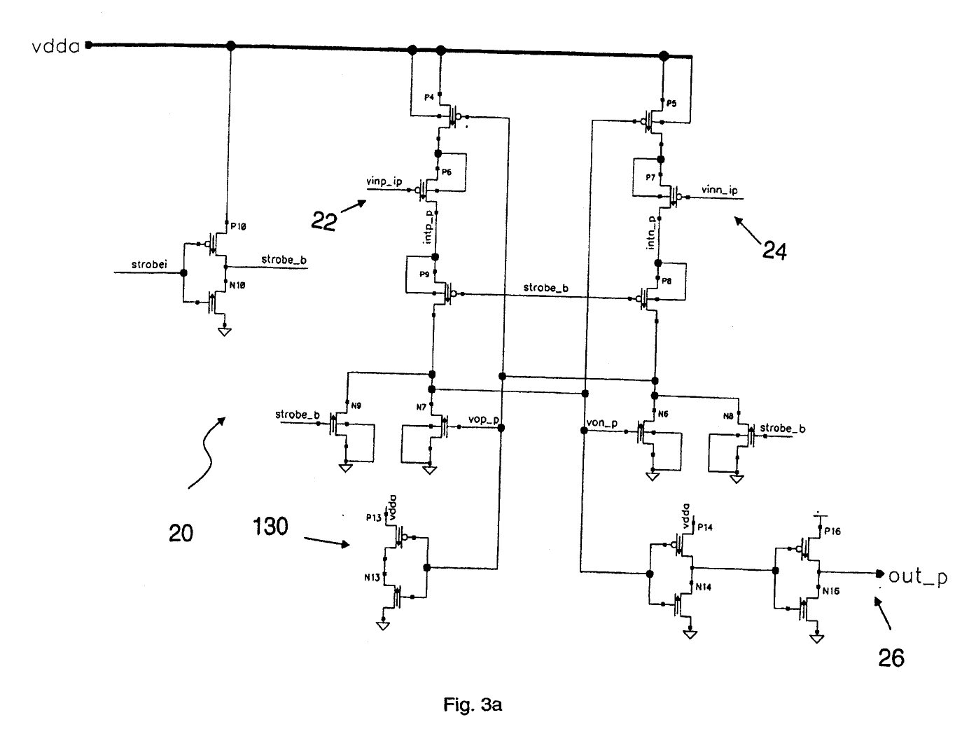

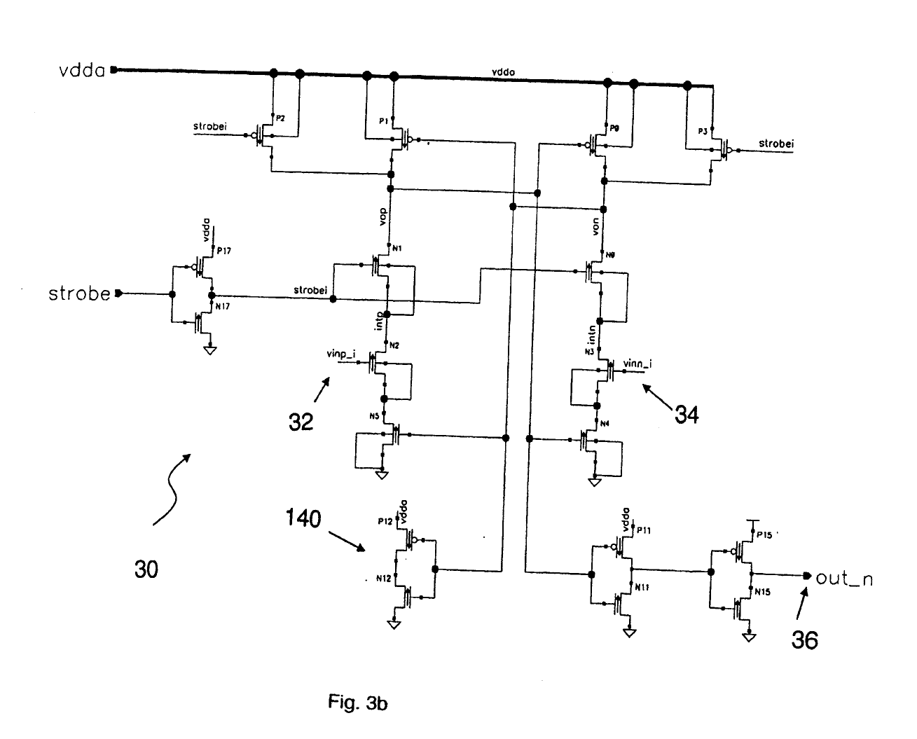

Most preferably, the first comparator 20 is equipped with pMOS transistors and therefore adapted for low input voltage levels and the second comparator 30 is equipped with nMOS transistors and therefore adapted for high input voltage levels. Details of the implementations are described in more detail in FIGS. 3a and 3b.

A voltage source is coupled to the selection unit 60 which, for example, comprises a simple voltage divider 120 with a first resistor unit 122 and a second resistor unit 124. The center tap of the voltage divider 120 is connected to an input port 104 of a third comparator 100. Another input port 102 of the third comparator 100 is connected to one of the input voltage signals Vin_p or Vin_n fed to the two comparators 20, 30. In this example, the input port 102 is connected to the positive Vin_p voltage signal.

The third comparator 100 can be a low accuracy component of a simpler design than the first and second comparators 20, 30. the third comparator 30 feeds a digital selection signal Vs from its output port 106 to a select input port 118 of a multiplexor 110 which assigned to the selection unit 60.

The output ports 26, 36 of the first and second comparators 20, 30 are connected to input ports 112, 114 of the multiplexor 110. Depending on a selection condition one of the input ports 112, 114 and thus one of the output ports 26, 36 of the first and second comparators 20, 30 are connected through to an output port 116 of the multiplexor 110.

Preferably, the selection condition is a threshold voltage signal. The selection unit 60 selects one of the comparators 20, 30 depending on the voltage signal Vin_n, Vin_p being above or below a threshold voltage V0. The threshold voltage V0 is generated by the voltage divider 120 and is, for example, in the middle of the operating voltage Vdd of the devices with V0=Vdd/2. If the input voltage Vin_p, Vin_n is above V0, the output port 36 of the second comparator 30 is connected to the output port 106 of the multiplexor 110. If the input voltage Vin_p, Vin_n is below V0, the output port 26 of the first comparator 20 is connected to the output port 106 of the multiplexor 110. The third comparator 100 feeds the appropriate decision signal Vs to the select port 118 of the multiplexor 110. The selection unit 60 selects the very comparator 20 or 30 with the best gain for the actual input voltage Vin₋p, Vin_n in a digital way.

This results in an optimal selection of the most sensitive component, either comparator 20 or comparator 30, especially for the most critical cases, where both input voltage signals Vin_p and Vin_n are close together and a high comparator gain is needed.

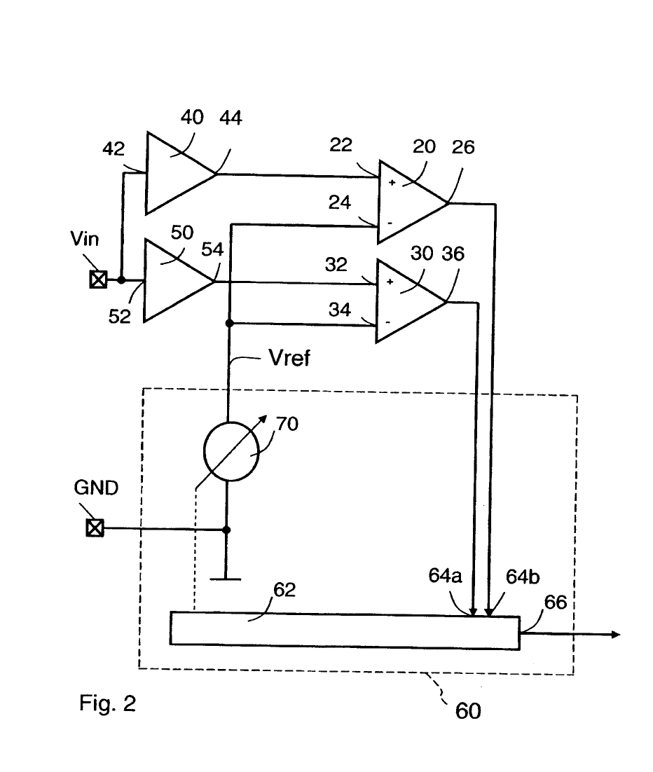

The preferred embodiment depicted in FIG. 2 represents a preferred high accuracy rail-to-rail analog-to digital converter. A comparator circuit comprises a first comparator 20 and a second comparator 30 and a selection unit 60. The selection unit 60 is indicated with a dotted line.

An input buffer stage 40 with an input port 42 and an output port 44 is assigned to the first comparator 20 and an input buffer stage 50 with an input port 52 and an output port 54 is assigned to the second comparator 30.

An input voltage signal Vin is fed through the buffer 40 into an input port 22 and an input voltage signal Vref is fed into an input port 24 of the first comparator 20. An output port 26 of the first comparator 20 feeds an output signal to the selection device 60.

An input voltage signal Vin is fed through the buffer 50 into an input port 32 and an input voltage signal Vref is fed into an input port 34 of the second comparator 30. An output port 36 of the second comparator 30 feeds an output signal to the selection unit 60.

Most preferably, the first comparator 20 is equipped with pMOS transistors and therefore adapted for low input voltage levels and the second comparator 30 is equipped with nMOS transistors and therefore adapted for high input voltage levels. Details of the implementations are described in more detail in FIGS. 3a and 3b.

A voltage source 70 is coupled to the selection unit 60, yielding a reference voltage Vref, which can be biased by a digital control unit 62. In the first conversion step for the most significant bit MSB, the reference voltage Vref corresponds to a threshold voltage V0 equal to Vdd/2, wherein V0 represents the selection condition. The comparator 20 or 30 selected in the first step is used for the following conversions steps.

The output port 26 of the first comparator 20 and the output port 36 of the second comparator 30 are connected to the selection unit 60 via input ports 64a and 64b, respectively. Depending on the selection condition either the output port 26 or the output port 36 is connected directly or indirectly to an output port 66 of the selection unit 60.

For a first conversion step of the analog to digital conversion, when the most significant bit MSB is determined, V0 is at Vdd/2 and equals Vref, i.e. both comparators 20, 30 work at a high gain operating point resulting in a high accuracy. Therefore the first conversion step can be based on one of the two comparators 20, 30 without preference. The result of the first conversion step indicates the voltage plane of the input voltage Vin, i.e. in the range Vin>Vdd or Vin<Vdd.

This result can be used to switch to the comparator 20 or 30 with the appropriate gain for the expected input voltage Vin for all following conversions down to the least significant bit LSB, finally yielding in a high accuracy rail-to-rail operation of the analog-to-digital converter. The shown principle can even be generally expanded to the input buffer stages 40, 50.

Preferably, the first and second comparators 20, 30 are latch-type comparators, as depicted in FIG. 3a and FIG. 3b. Such comparator types are generally known in the art, as for example suggested for an nMOS latch-type comparator by Won-Chul Song et al., which has already been discussed in the introduction.

FIG. 3a shows a comparator 20 equipped with pMOS transistors and FIG. 3b shows a comparator 30 equipped with nMOS transistors. Other than in the prior art cited above, these devices comprise a dummy inverter 130 and 140, respectively, to provide a more symmetric output stage, and are adapted to a preferred SOI technology (SOI=silicon-on-insulator) with body contact devices, which in principle is common to skilled persons.

Whereas the gain of the nMOS based comparator is in acceptable range at high input voltages Vin, with Vin>2Vdssat.n, wherein Vdssat.n is a saturation voltage of the nMOS-transistors, the pMOS based comparator works at its optimum for low input voltages Vin, with Vin<Vdd−2Vdssat.p, wherein Vdd is the operation voltage and 2Vdssat.p is a saturation voltage of the pMOS-transistors. As known in the art, Vdssat is the saturation voltage of a transistor where the transistor is operated in its pinch-off regime, where the gain of the transistor is at its maximum. Vdssat is the voltage drop between the drain and the source of the transistor which is necessary to operate the transistor in its saturation regime at the respective gate-source-voltage (or the respective drain-source current).

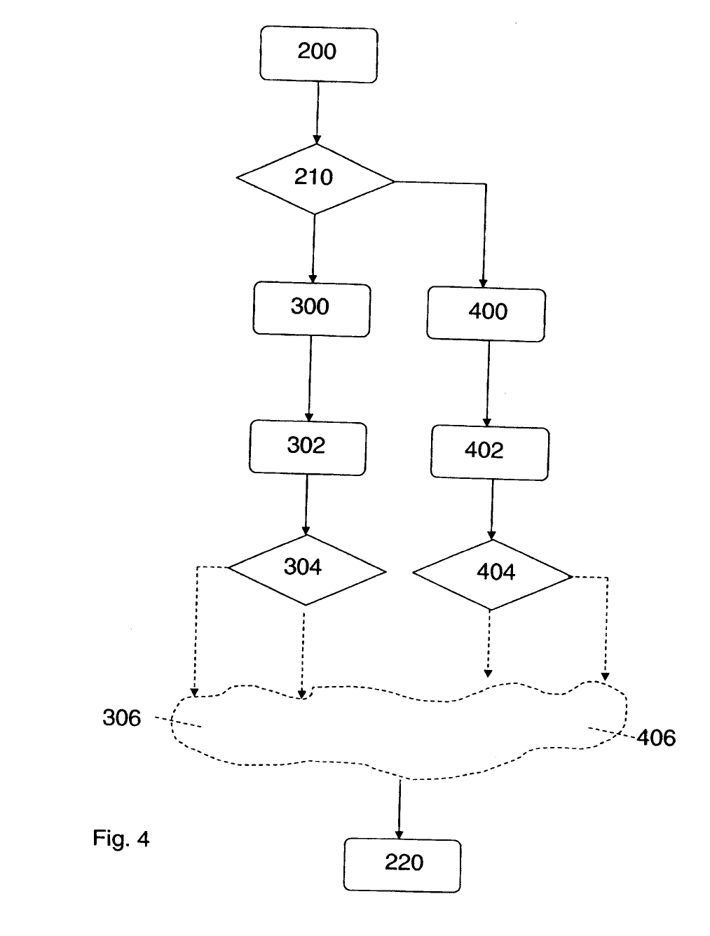

A preferred algorithm for operating the analog-to-digital converter shown in FIG. 2 is a successive approximation mode as depicted in FIG. 4. In principle, an analog-to-digital conversion working with successive approximation is known in the art. For the preferred embodiment of FIG. 2, the successive approximation conversion method is expanded to two comparators 20, 30.

For a first conversion step 200 of the analog to digital conversion, when the most significant bit MSB is determined, V0 is set to Vdd/2. After the first conversion step 200, the appropriate comparator is selected in step 210. In this first step 200, the threshold voltage V0 is equal to the reference voltage Vref.

At this point, both comparators 20, 30 work at a high gain operating point resulting in a high accuracy. Therefore the first conversion step 200 can be based on one of the two comparators 20, 30 without preference. The result of the first conversion step indicates the voltage plane of the input voltage Vin, i.e. in the range Vin>Vdd/2 or Vin<Vdd/2. In this example, the second comparator 30 is used in the first step 200.

In step 210 a comparison is made if the input voltage signal Vin is above the threshold voltage V0, Vin>V0. If Vin is below Vin, the first comparator 20 is selected in step 400 and the MSB is cleared. If yes, that is if a high input voltage is present, the conversion is continued with the second comparator 30 and the MSB is set in step 300. As already mentioned, the second comparator 30 is used for the following conversions in this example.

In step 302, following after step 300, the reference voltage Vref is set to the middle of the voltage interval: Vref=Vdd/2+Vdd/4, which is equal to middle of the detected voltage interval in the first step and the proper voltage interval for the next bit is selected.

In step 304, following after step 302, a comparison is made if the input voltage signal Vin is above the reference voltage Vref: Vin>Vref and so on, according to a usual successive approximation conversion.

If after step 210 the comparison shows that the input voltage signal Vin is below the threshold, the first comparator 20 is selected in step 400 and the MSB is cleared. In this case, the first comparator 20 is used throughout the following conversions.

Then in step 402, following after step 400, the reference voltage Vref is set to Vref=Vdd/2−Vdd/4, which is equal to middle of the detected voltage interval in the first step.

In step 404, following after step 402, a comparison is made if the input voltage signal Vin is below the reference voltage Vref: Vin<Vref, according to a usual successive approximation conversion. The conversion is continued with the first comparator 20.

Several following steps 306 and/or 406 are continued until the conversion is complete in step 220.

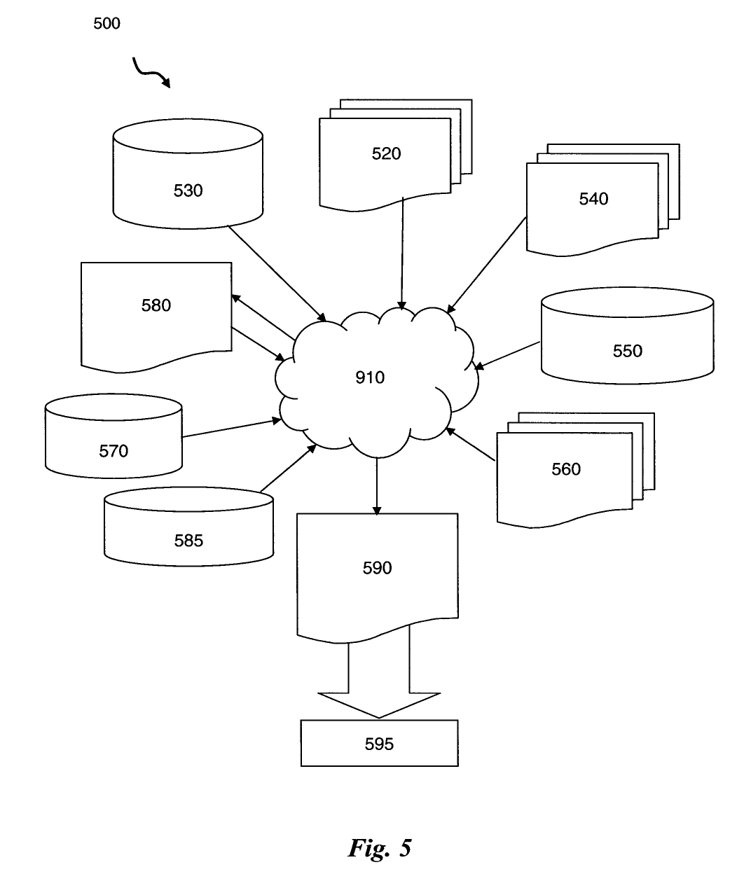

FIG. 5 shows a block diagram of an example design flow 500. Design flow 500 may vary depending on the type of IC being designed. For example, a design flow 500 for building an application specific IC (ASIC) may differ from a design flow 500 for designing a standard component. Design structure 520 is preferably an input to a design process 510 and may come from an IP provider, a core developer, or other design company or may be generated by the operator of the design flow, or from other sources. Design structure 520 comprises the comparator circuit in the form of schematics or HDL, a hardware-description language (e.g., Verilog, VHDL, C, etc.). Design structure 520 may be contained on one or more machine readable medium. For example, design structure 520 may be a text file or a graphical representation of the comparator circuit. Design process 510 preferably synthesizes (or translates) the comparator circuit into a netlist 580, where netlist 580 is, for example, a list of wires, transistors, logic gates, control circuits, I/O, models, etc. that describes the connections to other elements and circuits in an integrated circuit design and recorded on at least one of machine readable medium. This may be an iterative process in which netlist 580 is resynthesized one or more times depending on design specifications and parameters for the circuit.

Design process 510 may include using a variety of inputs; for example, inputs from library elements 530 which may house a set of commonly used elements, circuits, and devices, including models, layouts, and symbolic representations, for a given manufacturing technology (e.g., different technology nodes, 32 nm, 45 nm, 90 nm, etc.), design specifications 540, characterization data 550, verification data 560, design rules 570, and test data files 585 (which may include test patterns and other testing information). Design process 510 may further include, for example, standard circuit design processes such as timing analysis, verification, design rule checking, place and route operations, etc. One of ordinary skill in the art of integrated circuit design can appreciate the extent of possible electronic design automation tools and applications used in design process 510 without deviating from the scope and spirit of the invention. The design structure of the invention is not limited to any specific design flow.

Design process 510 preferably translates an embodiment of the invention as shown in [fill in figure or figures that represent the design], along with any additional integrated circuit design or data (if applicable), into a second design structure 590. Design structure 590 resides on a storage medium in a data format used for the exchange of layout data of integrated circuits (e.g. information stored in a GDSII (GDS2), GL1, OASIS, or any other suitable format for storing such design structures). Design structure 590 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in [fill in figure or figures that represent the design]. Design structure 590 may then proceed to a stage 595 where, for example, design structure 590: proceeds to tape-out, is released to manufacturing, is released to a mask house, is sent to another design house, is sent back to the customer, etc.

1. A design structure embodied in a machine readable medium for designing, manufacturing, or testing a design, the design structure comprising:
a comparator circuit for comparing a first voltage signal to a second voltage signal comprising a first comparator and a second comparator and a selection unit for selecting one of the comparators depending on a selection condition.

2. The design structure of claim 1, wherein the design structure comprises a netlist, which describes the circuit.

3. The design structure of claim 1, wherein the design structure resides on storage medium as a data format used for the exchange of layout data of integrated circuit.

4. The design structure of claim 1, wherein the design structure includes at least one of test data files, characterization data, or design specification.

5. A design structure embodied in a compute readable medium for performing a method, the method comprising:
comparing a first voltage signal with a second voltage signal, characterized in that either a first comparator or a second comparator is selected depending on a selection condition

6. The method according to claim 5, wherein the most accurate one of the two comparators is selected depending on the threshold voltage.

7. The Method according to claim 6, wherein an nMOS-based comparator is selected if the voltage level is above the threshold voltage and a pMOS-based comparator is selected if the voltage level is below the threshold voltage.

8. The method according to at least one of the claim 7, wherein an analog-to-digital conversion is made, and further wherein in the beginning of the conversion one of the comparators is chosen depending on the threshold voltage.

9. Method according to claim 8, wherein in the beginning of the successive approximation analog-to-digital conversion the selection of one of the comparators and a first analog-to-digital conversion is performed in the same step.
